(19) United States
(12) Patent Application Publication
(10) Pub. No.: US 2003/0227696 A1
(43) Pub. Date: Dec. 11, 2003

(54) Telescope sparse array not requiring the use of laser interferometry

(76) Inventor: David Joel Maker, Huntsville, AL (US)

Correspondence Address: David J. Maker, 7807 Hilton Dr., Huntsville, AL, 35802, US

(21) Appl. No.: 10/163,903

(22) Filed: Jun. 6, 2002

(51) Int. Cl. G02B 23/00

(52) U.S. Cl. 359/850; 359/399

(57) ABSTRACT

Recent schemes have been accepted by NASA in its TPF program for simple sparse arrays. But these methods require a great deal of interferometric control of tip tilt and other motion. But with this invention we just need (actuated) flats on a parabola with a central focal point module. The mirrors will be on the order of a kilometer distant from that module so that tip tilt can be sensed (and then controled) by sensors on the module that also detect beam pointing. The actual (high SNR) star the planet is orbiting can be used for rapid Strehle ratio maximization so that NO laser interferometry is needed at all. Fine mirror control can be done by variable reflectivity of the backside of the mirrors. The mirrors can be placed at L2 so that their orbits are all the same. A lot of this multi space craft control has already been accomplished with the ESA “Cluster”.

### CROSS-REFERENCE TO RELATED APPLICATIONS

Not applicable

### Statement Regarding Federally Sponsored Research or Development

There was no Federally sponsored research or development involved in this patent.

### BACKGROUND OF INVENTION

Two types of approaches have been recently accepted by NASA for its Terrestrial Planet Finder (TPF) program. One is the conservative, filled aperture approach which promises only about a 2 or 3 times increase in resolution over the NGST, so very little is gained in terms of extrasolar earthlike planet imaging. The second TPF method (using laser interferometry) involves a great deal of laser interferometric control of tip tilt and other motion for physically connected, deep dish (low F), hard to transport, large aberration mirrors and promises perhaps a factor of 10 increas in resolution thus with little gain for the effort and a nightmarishly complex laser interferometric control required. In any case a very large, kilometer wide or wider sparse array, is needed for imaging and resolving the surface of a extrasolar earthlike planet.

A solution to these seemingly intractable TPF problems involve these observations:

Methods for rapid Strehle Ratio maximization have been devised for segmented mirror telescopes looking at objects with a high SNR.

A very long (˜km) focal length mirror is nearly flat so that it can be cast very thin (as a flat) and actuated.

A LCD polymer can be used to change reflectivity and therefore momentum transfer of photons, thus used as a method of micron level position control for physically separate mirrors.

The 4 “cluster” spacecraft have shown that control of multiple space craft flying in tandem is possible.

In NGST research it was discovered that tip tilt sensitivity is approximately 7 times greater than piston phase sensitivity, therefore correspondingly difficult to compensate for (Motion of the mirror along the plane of the parabola is not nearly as critical). Laser interferometric control must be done at 6 DOF to compensate for tip tilt situation and would be a nightmare (or impossible) at best for a group of free flying mirrors. It would be clearly be extremely advantageous to do this control without requiring this laser interferometry and using flat mirrors.

### BRIEF DESCRIPTION OF THE DRAWINGS

Figure A Sparse Array space telescope (Idealized)

Figure B Sparse Array Mirrors on parabola at L2 with focal point module

Figure C Sparse Array Mirror with solar shield and actuators with micron level control

### DETAILED DESCRIPTION OF THE INVENTION

In contrast this invention just needs (actuated) flats on a parabola with a central focal point module. The mirrors will be on the order of a kilometer distant from that module so that tip tilt can be sensed (and then controlled) by sensors on the module that also detect beam pointing. So nothing new must be added to solve the most difficult problem of them all! The actual (high SNR) star the planet is orbiting can be used for rapid Strehle ratio maximization so that NO laser interferometry is needed at all. Fine mirror control can be done by variable LCD reflectivity of the backside of the mirrors. The mirrors can be placed at L2 so that their orbits are all the same. A lot of this multi space craft control has already been accomplished with the ESA “Cluster”.

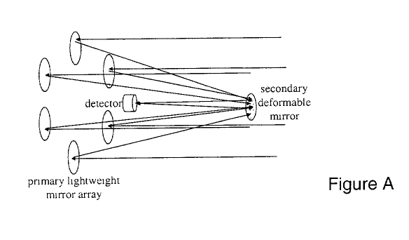

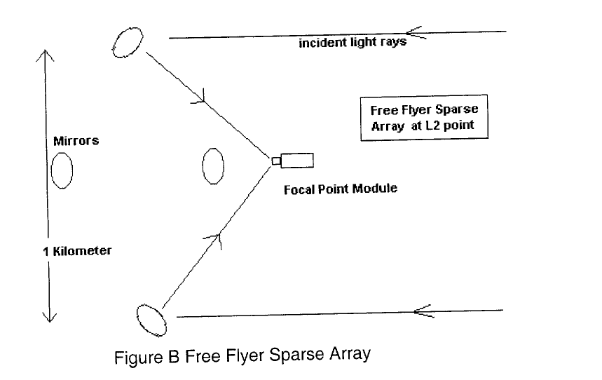

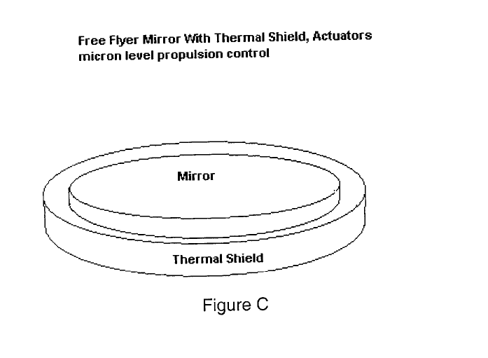

This Ultra-thin, lightweight mirror sparse array could revolutionize the imaging of the cosmos. Future space telescopes and observatories require very large collecting areas in order to achieve goals set forth by NASA, such as detecting and imaging extra-solar planets and studying the early universe [1]. In order to drive the costs of these large telescopes down, the overall mass must be reduced dramatically. FIG. 1 shows the Sparse Array Telescope (SAT), which consists of free-flying mirrors separated by distances of hundreds to thousands of meters. SAT element spatial configurations such as the Golay 6 [7] will be analyzed to determine the optimum architecture for a space-based SAT system.

The obvious benefits for such a system include the ability to detect extra-solar planets, find evidence of extra-solar life, and study the early universe. Secondly, such a system is both affordable and technologically feasible since it does not require laser interferometry.

Preliminary analysis conducted suggests that contrast problems associated with the small filling factor of SATs are minimized in a Circle 6 or a Golay 6-type configuration. Hence, the Circle 6 configuration will be used as a baseline to compare with other spatial configurations. Since the SAT individual elements are on the order of 1 km or more from the common focal plane of the optical system, a common mirror control methodology must be used to maintain an image at the focal plane. Measurement of beam direction (light reflected from the mirrors) at the common focal plane allows for an automated negative feedback control of mirror tilt and position. Use is made of conventional active optics techniques at the secondary mirror. Although the individual elements of the SAT are free to move in 6 degrees of freedom (6 DOF), optically only 1 DOF has to be considered because the large focal length of the system allows tip-tilt error correction via sensors at the focal plane. Also, the wavefront sensitivity is low for motions parallel to the primary's paraboloid surface (discussed further in section 2). In other words, the motions of the mirrors, parallel to the optical path, is the main contributor to image distortion. This suggests that the SAT could attain the resolution of an equivalently dimensioned monolithic mirror!

A second issue addressed here is mirror fabrication. The individual mirrors are far from the focal plane, so they are nearly flat and very thin, making for easy fabrication and also for single deployment (e.g., they are stacked on top of each other and deployed from the shuttle's payload bay). Flat mirrors also have very small, intrinsic aberrations such as coma. Hence, the use of multiple flat mirrors will aid in reducing various types of wavefront aberrations as well.

Strehl ratio maximization is also a critical issue. Strehl ratio maximization is an innovative wavefront correction approach. The method uses the bright star the extra-solar planet is orbiting as the point source for making the Strehl measurement. The Strehl ratio is optimized by translating the individual secondary mirror elements.

A laser rangefinder is used to fix the primary mirror position (relative to the focal plane module) to within a millimeter. An actuator then moves elements of the deformable secondary mirror (in the focal plane module) over this 1 mm range so that an intensity vs. position translation measurement is made. The measured curve is fit to a Gaussian curve. The secondary is then translated so that it is sitting on the nearest fringe to the peak of this Gaussian curve. The station keeping of the SAT secondary correction process should be very fast and periodic and could be automated easily. These methods have been developed also for segmented mirror telescopes.

An added benefit to the SAT system is that micrometeoroid impacts on the mirrors would register negligible optical signatures since they would be 1/r² diffuse signatures and the distance r here is on the order of a kilometer.

Each mirror is 2 cm thick (maximum). Each mirror, plus its ribbing cross supports, need not be more than a half meter in thickness. Six mirrors then would be approximately 3 m thick. The focal point module adds about 4 more meters. Thus, the space shuttle cargo bay could contain this 7-m long object. There is still the option of packing a huge, inflatable or preformed thermal shield for the whole array. Mark Gerry of MSFC has already explored this option for the NGST. Such a huge shield is not required since each mirror can be equipped with its own solar shield. The weight of six 3 m aperture mirror-flats can be less than about 15000 kg, which is not prohibitive for a shuttle payload (which could be as large as 20,000 kg).

A SELF ORGANIZING DEPLOYMENT: One method for easily deploying the mirrors from the shuttle cargo bay is to use individual microwave transmitters (set at different frequencies for each mirror) at the focal point apparatus. Each mirror would simply move (using gas jet control) to the position of maximum microwave power. Thereafter, the laser ranging would be used to get an approximate radial position with the gyros fixing the preprogrammed orientation with respect to the central-focal plane hub. This methodology would require a minimum of software writing, and so in a sense would be a self-organizing deployment.

Focal Point Module

At the focal point is an array of refractors for combining the light from the respective mirrors. There is one refracting telescope for each mirror. Refractors are used since obstructions in reflecting telescope optical paths (e.g., secondary mirror supports) cause many complications in the deconvolution process. The field of view of each refracting telescope is a circular projection on the telescope mirror. The beams from the refracting telescopes reflect from an actuated secondary mirror and are combined in a beam-combining element to form one beam. The beams are then recorded as an image. This process must be done in such a way that the beams are phase matched in the plane. The only beam interference must be due to the (astronomical) source wavefront itself. If the CCD focal plane is 0.6 mm wide (each beam is about 0.3 mm wide, so this is possible), with the beam from one of the mirrors being 0.6 mm. The distance needed to combine the beam to get the correct exit pupil geometry can be determined from:

$$\frac{x}{.0006} = \frac{.0006}{.1 λ} = \frac{.0006}{5 \times {10}^{- 8}} \qquad ( 1 )$$

where x is the minimum distance between the secondary and the detector plane and □=500 nm. Hence, the wave fronts combine without interfering (at least to 1/10 wave) if x=7.2 m, which is just small enough to fit into the focal point module.

This idea is remotely similar to the ground demonstration Golay 6 conceptual design performed at Phillips laboratory in Albuquerque, N. Mex. However, in this case, the secondary hyperboloid is eliminated for each mirror and is replaced with a focal point module. This combines the focal point and secondary modules into one and allows for the relatively large volume needed for mirror pointing control. Therefore, the technical requirements for Golay 6 ground deployment are very different from those relating to space-based deployment.

1/10 Wave Control (Wobble [tip/tilt] Control and Piston Control)

The core concept in understanding wavefront control using a telescope is that of imaging a point source. Thus mirror motion perpendicular to the wavefront direction (toward the focal point) is not nearly as critical as that caused by a mirror element wobble, which strongly redirects the light away from the focus point for the point source. Piston motion must be accurate to 1/10 wave. Coarse control is accomplished via the familiar inertial guidance attitude controls used by space telescopes such as the Hubble, SOHO, etc. Laser ranging for distances between the mirror and the focal point apparatus, with the side lobes of the laser beam, is used for coarse angular control.

CONTROL OF TIP TILT USING BEAM POINTING: Six DOF can be reduced to 1 DOF piston phasing control because the large mirror distance from the focal plane apparatus allows sensors at the focal plane to be used for beam pointing as well as for the control of tip-tilt phasing. Therefore, no extra effort is needed to control tip tilt. This result can be proven using simple geometry.

NGST telescope wavefront errors are over 10 times LESS sensitive to radial misalignments (along the line between the mirror and the focal point apparatus) than for individual segment errors [8]. These misalignments can be dealt with by beam misalignment detection near the focal point. This makes sense in terms of spot diagram arguments. This can also be understood in terms of the Zernike polynomials, whereas wavefront directional propagation distortion is affected very little by slight mirror motion along the beam axis.

Also, motions along the beam axis require radial phasing, which is discussed below. However, motions of one mirror edge, relative to another on the same mirror, do require about 1/10 wave accuracy and do cause a large degradation in the image of a point source. This amount of control requires typical pointing methodologies. One way of pointing is to use the image of the star near the planet. An off axis mirror diverts the light from the star and is used to point the beam of each mirror. The thrusters adjusting the radial position of the mirror are controlled by three (collimation) sensors—NOT the inertial guidance system. Fast primary mirrors are very sensitive to collimation errors. To find the minimum diameter of a point stellar source for a 3 m mirror at 1 km:

$$\frac{1.22 λ}{D} = \frac{1.22 \times 5 \times {10}^{- 7}}{3.5} = θ = 1.74 \times {10}^{- 7} = \frac{x}{1000} \qquad ( 2 )$$

So, x≈0.174 mm is the minimum diameter at the focal point. If one side of the mirror has moved 1/10 wave radially relative to the other side 3 meters away, then at the focal point 1000 meters distant, the beam will have moved approximately 1/30 of a millimeter. This is shown by using similar triangles and the fact that the law of reflection implies that the angle of light path deviation change be twice the mirror angle change. Therefore:

$$\frac{x}{1000} = 2 \frac{( 1 / 10 ) 5 \times {10}^{- 7}}{3.5} \qquad ( 3 )$$

where x≈1/35 mm. If the beam decreased uniformly in intensity from the center out to 0.1 mm, then beam intensity changes of 1 part in 3 would not be detected. These beam intensity changes are to be measured (and normalized) relative to the other two sensors (separated by 120°), so fluctuating beam intensities will not alter this result. Detection of light intensities to 1 part in 3 is easily done (limb darkening on resolved, stellar images slightly complicates this picture). In any case, this kind of pointing error is required for imaging purposes. Therefore, no additional control is required! In addition, the interferometry wobble problem (e.g., SAMSI, other Golay projects) that has been the bane of sparse arrays can be overcome in this particular situation by doing nothing extra. The irony is that this solution would not be possible with much shorter focal length arrays since the diameter, x, would be proportionally smaller, thereby increasing the difficulty of measurement. It is no wonder that this method of mirror control has not been contemplated before; it should work best on a planet imager! It should be noted that because of the large mirror to focal plane distance, phasing is relatively insensitive here to mirror motion parallel to the sparse array and mirror paraboloids (±1 meter). Thus, conventional means (e.g., gyros) can be used to control this type of motion.

Piston Radial Distance Phasing

For radial distance phasing, the crude position controls (e.g., laser ranging) put the radial position within a couple of thousand wavelengths accuracy. The final part is accomplished by maximizing the Strehl ratio, using the curve fitting procedure discussed in section B below.

LASER RANGING: It was learned from NGST that the initial radial position must be within 1 mm (to begin the Strehl ratio maximization), which in this case, laser metrology on a elbow mirror at the focal point apparatus (laser ranging used in surveying) can already do. “The DISTO pro has a standard accuracy tolerance of plus/minus 1.5 mm over its entire working distance, which in most cases is limited to 100M” [9]. In a vacuum, the tolerance promises to be much more refined (fraction of a millimeter).

The mirror position could be stabilized by the use of an unequal path interferometer, such as Kocher's, with phase-lock on the correct Strehl ratio distance. Unequal path interferometers require frequency-stabilized lasers. A phase-lock (within 1 mm) can be obtained by using two frequencies on the interferometer of about 20 A wavelength separation. There would then be one point where even peaks are at a true minimum within that millimeter (which itself is derived from laser ranging). Another promising method [10] is to interrogate an interferometer at two separate wavelengths. The difference of these two wavelengths is such that the two signals are in quadrature. Therefore, a vector calculation will give the phase difference independent of the absolute phase difference. However, laser interferometry will not be needed for this SAT approach. This will be discussed later.

STREHL RATIO MAXIMIZATION: The Strehl ratio maximization procedure is accomplished just after the laser ranging (accurate to ±1 mm) is completed and makes use of the bright star that the planet orbits with planet imaging being done on a parallel paraxial focal plane region. After laser ranging, a gas jet thruster will cause the primary to move to the middle of that 1 mm region given by the readout of the laser ranger. Then, the secondary will move the full millimeter distance, and the computer will be used to fit a Gaussian curve to the intensity vs. position curve. The actuator will then move the secondary mirror (reflecting the light of just this single mirror) to the center of this calculated Gaussian and then move it much more slowly to the first bright fringe. This method is far faster than going individually through each of the 10,000 fringes for Strehl ratio maximization, which is usually contemplated. The point is to implement millisecond Strehl ratio maximization so that there will be no need for laser interferometry. Since the star the planet orbits will be bright, this process can be completed in milliseconds while planetary imaging is being done. Thereafter, there will be periodic “station keeping” of the secondary mirror actuator on that first bright fringe.

In this process, one mirror is used as a reference and the Strehl ratio for all the other mirrors is maximized with this reference. Finally, all the mirror beams are combined and the position is maintained for a few seconds while imaging is taking place, and then the process is repeated.

Strehl ratio maximization must also be used to control imperfections in the individual mirrors shape via the actuators, and this is done just after deployment. Such control would be periodic and automatic.

Another advantage of this Strehl maximization procedure is that it would allow use of Ritchey-Cretin telescope optics since the whole apparatus is tested at once from exit to entrance pupil. This forces nearly all the lowest order (intrinsic) aberration Seidal coefficients to zero.

F-NUMBER: The F-number is about f/2 to take advantage of the long focal lengths (since effective aperture size is the main goal) with an effective focal ratio of perhaps f/8 due to the beam combiner. The amplifying power of the beam combiner (acting like a secondary mirror in a Schmidt-Cassegrain) produces the long effective focal length and small effective focal ratio. Typically, the positioning tolerance of an f/8 Newtonian's rack and pinion is about 0.002 inch, while the position tolerance of the Schmidt-Cassegrain's primary f/2 must be to approximately 0.0001 inch. This is about 1/20 the Newtonian, which is still tolerable focusing. The effective “motion” of this primary (the large mirrors in our case) in the Schmidt-Cassegrain situation corrects this position tolerance.

Magnitude and Resolution Requirements

By comparison, the sun has an apparent magnitude of −26½, and Venus (an earth-size planet) at its brightest −4 at a distance comparable to the earth's distance from the sun (at maximum elongation). Therefore, there is a 22.5 magnitude difference. So if, for the sake of argument, the sun were a 1st magnitude star at the distance of α centauri (˜3 parsecs), then Venus would be magnitude 23.5 at this distance. 27th magnitude objects can be imaged via Hubble with about an hour exposure time. There are 6 such mirrors in this array, raising the magnitude to about 29. So, there is a buffer zone of about 6 magnitudes. This number is reduced about a magnitude (to magnitude 5) due to the low contrast properties of the small sparse array filling factor. However, the use of the Golay 6 minimizes this contrast problem, and matched filtering would offer even more improvement. Recall that magnitude 5 means a 100 times difference in brightness. This is about the brightness difference between the dimmest visible naked eye stars and a star such as Rigel. So a planet about a 100 times dimmer than Venus (at 3 parsecs) could be imaged with this array. Therefore, this telescope does have enough collecting area to image earthsize extra solar planets.

The absolute minimum aperture required to image an extrasolar earthsize planet can be found from the Rayleigh criterion [11]

$$a ( z ) = \frac{.61 λ z}{D} , \qquad ( 4 )$$

where a(z) is the aperture diameter as a function of distance, z, λ is the wavelength, and D is the diameter of the earth.

METEORIC DEGRADATION: At the L2 point, meteoric degradation is not a problem. It was concluded that at the L2 lagrangian point, only 0.18% surface was degraded over 10 years. This issue has been studied extensively [12].

It should be noted that <1 mm meteoric impact regions would give primarily diffuse reflection, so the effect on the imaging of a kilometer distant mirror (with these impacts on it) would be negligible (as opposed to the much smaller NGST distance effects). So, it is conceivable that the telescope could be put in low Earth orbit, since it is easy to show that it would take many such impacts to degrade the image appreciably. Thus, the “tried and true” magnetic angular momentum transfer used in the Hubble space telescope (since it is in the Earth's magnetic field) could be used here so that the finite supply of thruster gas would not be a problem. In any case, comparison studies need to be made regarding the kind of glass and/or membrane that would allow high velocity impacts to give diffuse reflecting impact regions (instead of specular).

Level of Difficulty of Wavefront Shape Control

The fine tuning needed here to get 1/10 wavefront control is actually about the same complexity of control as is needed for radio controlled model airplanes (i.e., 4 controls: the throttle, rudder, elevator, and aileron; over 6 AM channels.). There are only 4 controls needed (in addition to the usual coarse controls used on imaging satellites such as inertial guidance). For 1/10 wave, we only need 3 thruster wobble (two dimensional, 2 DOF) control, and that is easily accomplished by doing continuous collimation using the signals from sensors at the focal point module. Also, we need the much less demanding radial control (1 DOF) along the line connecting the mirror to the focal point for a total of 4 controls (versus the 4 controls for the radio controlled model airplane).

INTRINSIC ABERRATIONS: For purposes of calculating aberrations, we model each telescope in the sparse array as an extremely long focal length Cassegrainian. The mirrors would then lie on the imaginary surface of the Cassegrain. Seidal Coefficients [13] or Cassegrain for spherical, coma, astigmatism, and field curvature are:

$$\begin{matrix}{S}_{I} = - [ ( 1 + {b}_{p} ) - {( b , + \frac{m + 1}{m - 1} )}^{2} {( \frac{m - 1}{m} )}^{3} \frac{{F}_{p} - E}{F + {F}_{p}} ] \frac{{D}_{p}}{64 {F}_{p}^{2}} , & ( 5 ) \\ {S}_{II} = - [ \frac{1}{{m}^{2}} + {( b , + \frac{m + 1}{m - 1} )}^{2} {( \frac{m - 1}{m} )}^{3} ] \frac{{D}_{p} {φ}_{m}^{2}}{16 {F}_{p}^{2}} , & ( 6 ) \\ {S}_{III} = - [ \frac{m F + E}{m D} - {( b , + \frac{m + 1}{m - 1} )}^{2} {( \frac{m - 1}{m} )}^{3} ] \frac{{( F - E )}^{2}}{4 {F}_{p} ( F + {F}_{p} )} \frac{{D}_{p} {φ}_{m}^{2}}{4 ( {F}_{p} + E )} , & ( 7 ) \\ {S}_{IV} = [ \frac{1}{{F}_{p}} + \frac{1 - {m}^{2}}{m ( {F}_{p} + E )} ] \frac{{D}_{p} {φ}_{m}^{2}}{4} & ( 8 )\end{matrix}$$

As shown, bₚ and bₛ are the conic constants for the primary and secondary mirrors, (b=−e², e being the eccentricity), m is the magnification of the secondary mirror, Dₚ=diameter of the primary, F is the system effective focal length ratio, Fₚ is the primary mirror focal ratio, and φₘ is the semifield of view. For this Cassegrain (thus Sₗ=0), semifields of view are on the order of 1/100 of an arcsecond, E<<F, F and Fₚ is on the order 1000, and m=1, which yields a coma of about 10⁻⁸ λ and an astigmatism and field curvature of about 10⁻⁶ λ aberration. In fact, 10⁻¹ λ was tolerable. Therefore, the aberrations depend entirely on mirror surface accuracy, not the “type” of telescope (e.g., Cassegrain). Hence, Ritchey-Cretin telescope optics could be used here, since the whole apparatus is being tested simultaneously using Strehl ratio maximization. Several more of these Seidal coefficients would be forced to zero due to the simultaneous testing.

ORIENTATION AND LINEAR POSITION CONTROL DEVICES: The Hubble must keep a ±10×10⁻⁷ radian directional control just to keep its psf's on pixel and within the diffraction limit. This translates into a positional tolerance of one end (of that telescope) relative to the other of about 2 microns. However, the above sparse array situation results in 5×10⁻² mm/106 mm=0.2×10⁻⁷ radians, or 50 times better pointing accuracy. Radially, we require here a ±0.5/10=0.05 m tolerance. Our sparse array must be about 50 times more accurate in linear positioning as well! Note that linear positioning tolerances do not change for even much larger sparse arrays while the angular tolerances decrease. In that regard, there is some question as to whether gas jet control at a lagrangian point can ever be made as accurate as magnetic angular momentum dumping into the earth's magnetic field as is done in low orbit by the Hubble, for example. However, some alternatives to angular momentum dumping into a magnetic field exist for micron-level control. For example, one can also use liquid crystal display (LCD) changes in reflectivity to move mirrors within a reasonable time. Another alternative is to mount control vanes or small solar sails on each optic. Gas jets are not required for submicron control of certain types of motions.

Also, in low Earth orbit, Earth's magnetic field can be used for angular momentum dumping as the Hubble does. There would be no need for gas jet thrusting (cold gas jets run out of gas within months). But in that case, micrometeoroid degradation is large (especially around 800 km), and mirrors would have to be replaced periodically (˜2 years). Also, orbital velocities of these distant mirror elements would be noticeably different (given Keplerian motion) for low orbit sparse arrays, putting much more severe demands on station keeping than there would be at a lagrangian point.

An alternative to space based sparse array is a lunar based array. Placing the system on the moon would allow for a rigid platform with simpler element control mechanisms. Of course, a boom or tower would have to be constructed for mounting the secondary. However, lightweight structures could be constructed that would allow for this. The lunar alternative will be investigated as a secondary approach during this effort,

Array Configuration

The general trend is that a larger number of smaller elements can provide a required resolution limit with a minimum of aperture area. A Golay 6 or circle 9 configuration are optimal.

Interestingly, the family of Circle 6 and Golay 6 two dimensional nonredundant subaperture arrays results in nonredundant MTF passbands that are equally spaced [7], thus providing the most uniform, spatial frequency coverage within the cutoff spatial frequency aperture area. This is the optimal method for treating contrast problems, which are often mentioned as objections to these sparse arrays [14]. Circle 6 array as the baseline architecture. Apparently, this is also the choice for the Darwin sparse array. The ability to phase this many mirrors in a timely fashion is due to the rapid Strehl maximization procedure (discussed previously). Also, each mirror could implement a sun shield-solar array to block sun light to allow for focal plane cooling and possibly infrared imaging.

But there is a way to avoid the interferometry and use thin flat mirrors instead. For example you could use a golay 6 sparse f/2 sparse array with free flying thin flat (with actuation) mirrors giving a >1 kilometer effective aperture. These mirrors (each with ˜3 meter aperture) are be distributed over a hemispherical region in space, with a module placed at the common focal point. In this focal point module would be several small refracting telescopes (˜10 cm aperture, one for each of the mirrors) that focus the light from these various distributed (distant) mirrors to a common imaging device. Because of the long 1 km focal lengths used here wobble-tip tilt control (NGST research has found it to be the most difficult phasing problem to solve) can be done using the same sensors that control the beam pointing! No extra work is required to control the most difficult problem! So a seemingly intractable 6 DOF problem is reduced to a manageable 1 DOF piston phasing problem. This is the most important advantage of this method. And simple laser ranging can be used here to fix the mirror position to within about a millimeter. Rapid Strehl ratio maximization (as was developed for ground based segmented mirrors) on the star accompanying the planet can further fix the mirror piston position(piston phasing).

To summarise we have a way of doing the same extra solar earthlike planet imaging without the interferometry and using only thin flat glass mirrors (with actuation). The laser interferometry (especially tip tilt correction) you will need here may prove to be really difficult(or impossible?) so a method like this one is needed to fall back on.

### BRIEF SUMMARY OF INVENTION

With this invention we just need (actuated) flats on a parabola with a central focal point module. The mirrors will be on the order of a kilometer distant from that module so that tip tilt can be sensed (and then controlled) by sensors on the module that also detect beam pointing. The actual (high SNR) star the planet is orbiting can be used for rapid Strehle ratio maximization so that NO laser interferometry is needed at all. Fine mirror control can be done by variable reflectivity of the backside of the mirrors. The mirrors can be placed at L2 so that their orbits are all the same. A lot of this multi space craft control has already been accomplished with the ESA “Cluster”.Thus it is possible to build an extremely high resolution, multi kilometer baseline visible light TPF that operates without the use of laser interferometry.

### DETAILED DESCRIPTION OF INVENTION

There are 6 3 meter thin freeflying mirrors with actuation at a kilometer from the focal point module in that sparse array. The tiptilt is controled by sensors at the focal point module that control beam pointing. The piston control is done by rapid strehle ratio maximization on the star that the planet is orbiting. Fine mirror control can be done by variable reflectivity of the backside of the mirrors. The mirrors can be placed at L2 so that their orbits are all the same.

1. Flat mirrors with actuation are all that is needed here because of the large mirror distance.

2. For kilometer distant mirrors sensors at the focal point module used for detecting beam direction also compensate for tip tilt because of the large distance.

3. No other phasing but piston phasing is needed here.

4. Strehle ratio maximization on the piston phasing using the light from the high SNR star the planet is orbiting is all that is needed for piston phasing.

5. So no laser interferometry is needed for this multikilometer sparse array to be phased and then image the surfaces of extrasolar earthlike planets. This is new idea.
